(19) United States
(12) Patent Application Publication
(10) Pub. No.: US 2009/0025859 A1
(43) Pub. Date: Jan. 29, 2009

(54) Method and device for applying adhesive agent to coating elastic string-like material

(75) Inventors: Shoji Hidaka, Osaka-shi (JP); Seiki Tarumi, Osaka-shi (JP); Takashi Kida, Osaka-shi (JP); Eiji Yamazumi, Osaka-shi (JP); Fumio Takeuchi, Osaka-shi (JP); Tetsuo Maruyama, Osaka-shi (JP); Kenji Takahira, Otsu-shi (JP); Takatoshi Shibata, Otsu-shi (JP)

Correspondence Address: Quinn Emanuel Urquhart Oliver & Hedges;Koda/Androlia, 865 S. Figueroa Street, 10th Floor, Los Angeles, CA, 90017, US

(73) Assignees: Sun Tool Corporation; Opelontex Co., Ltd.

(21) Appl. No.: 11/919,769

(22) PCT Filed: Apr. 27, 2006
(86) PCT No.: PCT/JP2006/309520

§ 371 Date: Nov. 1, 2007

(30) Foreign Application Priority Data
May 2, 2005 (JP) 2005-134199

(51) Int. Cl. B29C 65/00; A46B 11/00

(52) U.S. Cl. 156/164; 401/48

(57) ABSTRACT

A method and a device for applying an adhesive to an elastic string-like material capable of performing continuous application operation without stopping the application operation by automatically jumping the knot of the elastic string-like material form a running line for the material at a slit groove 202 in a coater applying head. A slide guide body 210 positioned at a front side of the slit plate 201 in a transfer direction, having a detection guide groove 211 with a width of allowing the elastic string-like material to pass through but inhibiting the knot from passing through, and having a second expanded part 205 positioned at a part protruded from a tip end of the slide guide body 210 at a tip end extension part of the slit groove 202 of said slit plate 201, with a width of allowing the knot to pass through.

### TECHNICAL FIELD

The present invention relates to a method and a device for applying an adhesive agent to an elastic string-like material (polyurethane elastic string, flat rubber, and string rubber or the like) on a coating line [such as a manufacturing line of a paper diaper including the step of automatically bonding the string rubber to the diaper body] including a coating step of applying the adhesive agent to the elastic String-like material (polyurethane elastic string, flat rubber, and string rubber or the like). Particularly, the present invention relates to a coating step of applying the adhesive agent to a required elastic string-material (polyurethane elastic string, flat rubber, and string rubber or the like), in a manufacturing apparatus of a body fluid absorbent product (a disposable diaper or the like) including the step of gluing the elastic string-like material (polyurethane elastic string, flat rubber, and string rubber or the like).

### BACKGROUND ART

Regarding the coating step of applying the adhesive agent to the aforementioned elastic string-like material (polyurethane elastic string, flat rubber, and string rubber or the like), an applicant of the present invention (SUNTOOL CORPORATION) discloses the method for applying the adhesive agent to the elastic string-like material (flat rubber, and string rubber or the like) in Japanese Patent Laid Open Publication No. 2001-347209 (Patent document 1). According to the patent document 1, the adhesive agent is supplied to a slit groove having an open lower face and an expanded middle part, which communicates with an adhesive supply hole; a tense elastic string-like material (flat rubber, string rubber or the like) is made to horizontally penetrate the expanded part of the aforementioned slit groove; and this elastic string-like material (flat rubber, string rubber or the like) is supplied in a coating line proceeding direction, so that the adhesive agent is applied on an entire circumferential surface of the elastic string-like material passing through the slit groove, on the coating line including the step of applying the adhesive agent to a running elastic string-like body (flat rubber, string rubber or the like).

In the elastic string-like material (polyurethane, flat rubber, string rubber or the like), there is a knot of a terminating end and a starting end of before and behind a supplying bobbin, when replacing the supplying bobbin.

In the aforementioned prior invention, the adhesive agent is applied on the entire circumferential surface of the elastic string-like material (polyurethane elastic string, flat rubber, string rubber or the like) passing through the slit groove. Therefore, there is a problem that a diameter (sectional area) of the elastic string-like material is restricted to an allowable range, according to a relationship with a width (sectional area) of the slit groove. That is, the knot of the elastic string-like material is larger than the width (sectional area) of the slit groove, thus making it impossible to pass through the slit groove.

Accordingly, at the end of the elastic string-like material of the supplying bobbin, an application operation is stopped once to make a knot, and by a manual work, the knot is made to jump at a place of the slit groove, so that the knot of the elastic string-like material is prevented from passing through the slit groove. Therefore, a problem is involved, such as deteriorating work efficiency by stopping a work.

### DISCLOSURE OF THE INVENTION

Therefore, an object of the present invention is to enable a continuous application operation to be performed without stopping the application operation, by automatically jumping the knot of the elastic string-like material from a running line of the elastic string-like material at the slit groove.

Further, an object of the present invention is to enable inhibiting a mutual interference of the plurality of running elastic string-like materials when the adhesive agent is applied to the plurality of running elastic string-like materials, in a coating line including the step of applying the adhesive agent to the plurality of running elastic string-like material by a coater applying head for supplying the adhesive agent to the plurality of slit groove.

A first aspect of the present invention provides a method for applying an adhesive agent to an elastic string-like material, detecting a knot that exists in the elastic string-like material running on the coater applying head; based on a detection of the knot, so that it can pass while avoiding the slit groove, the knot of the elastic string-like material is promptly returned to the original running line, wherein the knot of the elastic string-like material jumping and passing through the slit groove of a slit nozzle of a slit nozzle coating position is promptly returned to the running line and can be continuity running, and the knot of the elastic string-like material is guided in a jumping direction, for automatically jumping the knot of the elastic string-like material from the running line of the elastic string-like material.

A second invention of the present invention provides a method for applying an adhesive agent to an elastic string-like material, having a coating line including the step of applying the adhesive agent to the plurality of running elastic string-like material by a coater applying head, for supplying the adhesive agent to the plurality of slit groove, which communicates with an adhesive supply hole and has an open lower face and an expanded middle part, making a tense elastic string-like material penetrate the expanded part of the slit groove horizontally, and supplying the elastic string-like material in a coating line proceeding direction,

A third invention of the present invention provides an apparatus for applying an adhesive agent to an elastic string-like material including a slit plate having a slit groove that communicates with an adhesive supply hole, for applying an adhesive agent to a running elastic string-like material, said apparatus comprising: a slide guide body 210 positioned at a front part in a transfer direction of a slit plate of the coater applying head, having a detection guide groove 211 with a width of allowing the elastic string-like material to pass through in an extension state but inhibiting the knot from passing through, with the detection guide groove 211 aligned with the slit groove of the slit plate in a transfer direction of the elastic string-like material, so that a guide terminal end of said slide guide body is approached to a tip end of the slit groove of the slit plate.

A fourth invention of the present invention provides an apparatus for applying an adhesive agent to an elastic string-like material including a slit plate having a plurality of slit grooves that communicate with an adhesive supply hole, for applying an adhesive agent to a plurality of running elastic string-like materials, said apparatus comprising: a slide guide body positioned at a front side of the slit plate in a transfer direction, having a detection guide groove with a width of allowing the elastic string-like material to pass through but inhibiting the knot from passing through, and having a second expanded part positioned at a part protruded from a tip end of the slide guide body at a tip end extension part of the slit groove of said slit plate, with a width of allowing the knot to pass through.

According to a first invention and a third invention of this application, when the knot that exists in the elastic string-like material running on the coater applying head is raised from the original running line passing through the slit groove of the nozzle coating position so that it can pass while avoiding the slit groove, the knot of the elastic string-like material is promptly returned to the original running line of the elastic string-like material just after jumping and passing through the slit groove of the slit nozzle coating position. Accordingly, the present invention has an advantage that in an adhesive non-applied section of the elastic string-like material in a product having the elastic string-like material integrally bonded thereto which is formed by bonding an adhesive agent applied elastic string-like material in an extension state in post steps, a natural length of the elastic string-like material in an extension state is very small, thus making it possible to substantially ignore an existence of the adhesive non-applied section over the knot of the elastic string-like material.

According to a second invention and a fourth invention of this application, when the adhesive agent is applied to a plurality of running elastic string-like materials in an extension state by the apparatus for applying the adhesive agent to the elastic string-like material for applying the adhesive agent to the plurality of running elastic string-like materials, all knots of the plurality of running elastic string-like materials during jumping the slit groove of the slit plate are set in a protruded state in the jumping direction at the time of landing on the running line, and the knots are prevented from protruding in a lateral direction (in a direction of the adjacent elastic string-like material). Accordingly, the present invention has an advantage of surely inhibiting a mutual interference of the plurality of running elastic string-like materials when the adhesive agent is applied to the plurality of running elastic string-like materials.

### BRIEF DESCRIPTION OF THE DRAWINGS

FIG. 1 is a perspective view of a coater applying head according to a prior invention.

FIG. 2 is a vertical sectional view of the same.

FIG. 3 is a front view of a coating line for manufacturing a paper diaper.

FIG. 4 is a plan view of the same.

FIGS. 5A and 5B are front views of the coater applying head on a manufacturing line of the paper diaper, FIG. 5A shows a case that the coater applying head is applied to a coating step of applying an adhesive agent to a plurality of string rubbers, and FIG. 5B shows a case that the coater applying head is applied to the coating step of applying the adhesive agent to a single flat rubber.

FIG. 6 is a perspective view of the paper diaper.

FIG. 7 is an explanatory view of a first distribution mechanism.

FIG. 8 is an explanatory view of a second distribution mechanism.

FIG. 9 is a sectional view taken along the line S1-S1 of FIG. 8.

FIG. 10 is a sectional view taken along the line S2-S2 of FIG. 8.

FIG. 11 is an explanatory view of a flow of the adhesive agent during an application operation.

FIG. 12 is an explanatory view of a flow of the adhesive agent by the first distribution mechanism and the second distribution mechanism during the application operation.

FIG. 13 is an explanatory view of a flow of the adhesive agent showing a valve action of an extrusion type for an intermittent application.

FIG. 14 is an explanatory view of a flow of the adhesive showing the valve action of a suction type for the intermittent application.

FIG. 15 is a vertical sectional view similar to FIG. 2 of the coater applying head, being an essential part of a device for applying the adhesive agent, according to an example of the prior invention.

FIG. 16 is a front view of a slit plate.

FIGS. 17A and 17B are expanded views of a slit groove, showing an example of the elastic string-like material as a string rubber of a rectangular sectional shape.

FIG. 18 is a front view of the coater applying head, being the essential part of the device for applying the adhesive agent, according to an example of the present invention.

FIG. 19 is a vertical sectional view of the same.

FIG. 20 is a left side view of the same.

FIG. 21 is a right side view of the same.

FIG. 22 is a front view of the slit plate.

FIG. 23 is an explanatory view of a numerical value of the slit groove.

FIGS. 24A and 24B are explanatory views of a detecting action and a jumping action of the knot of the present invention, FIG. 24A is a vertical sectional view of the coater applying head, and FIG. 24B is a left side view of the same, showing an approach state of the knot to the coater applying head.

FIGS. 25A and 25B are explanatory views of the same, showing a jump middle position of the knot.

FIGS. 26A and 26B are explanatory views of the same, showing a jump end position of the knot.

FIGS. 27A and 27B are explanatory views of the same, showing a landing position of the knot on a running line.

FIG. 28 is an explanatory view of a detecting action and a jumping action of the knot of the present invention, showing a first half step.

FIG. 29 is an explanatory of the same, showing a latter half step.

### BEST MODE FOR CARRYING OUT THE INVENTION

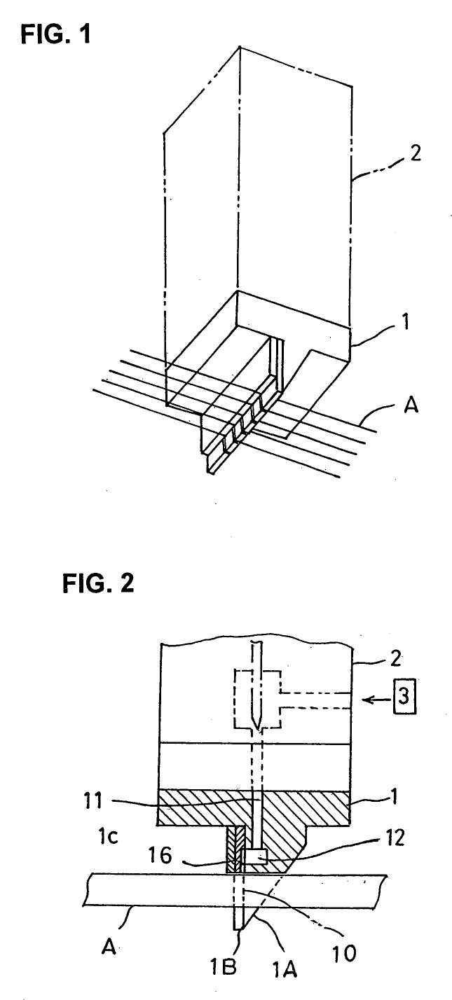

Prior to an explanation of an example of the present invention, a device for applying adhesive agent to an elastic string-like material (polyurethane elastic string, flat rubber, string rubber, or the like) on a coating line will be explained with reference to FIG. 1 to FIG. 4.

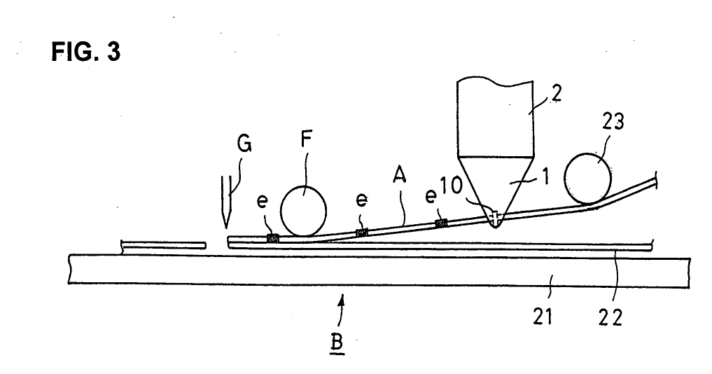

FIG. 2 and FIG. 3 are views showing an example of using a manufacturing line of a paper diaper including a step of automatically bonding a string rubber to the diaper body, as a coating line including a coating step of applying an adhesive agent H to the elastic string-like material (polyurethane elastic string, flat rubber, string rubber or the like).

A string rubber A or the like, running in a tense state (extended state) by a tension roller 23 is supplied to an upper part of a band shaped diaper body 22, with an adhesive applied position “e” of the string rubber A running in an upper part of the band shaped diaper body 22 aligned with an elastic material forming place (bonding place of the string rubber or the like) E in the band shaped diaper body 22 which is being transferred on an upper surface of a transfer conveyor 21 in a manufacturing line B.

The band shaped diaper body 22 is cut after a pressurizing step F and a cutting step G and only the elastic material forming place E of the string rubber A or the like, is bonded to the band shaped diaper body 22, thus forming an elastic material K, and a “paper diaper” 20 is completed. In the paper diaper shown in FIG. 6, R shows a vertically standing wall by the elastic material K formed of the string rubber.

The prior invention is executed in the step of applying the adhesive agent to the string rubber or the like, for supplying the elastic string-like material (flat rubber, string rubber or the like) A to which the adhesive agent H is intermittently applied in the aforementioned coating line B. The coater applying head B supplies the adhesive agent H to the slit groove having front face, rear face, and bottom face openings in a coating line proceeding direction, to make the string rubber A penetrate the slit groove 10 horizontally in a tense state (extended state).

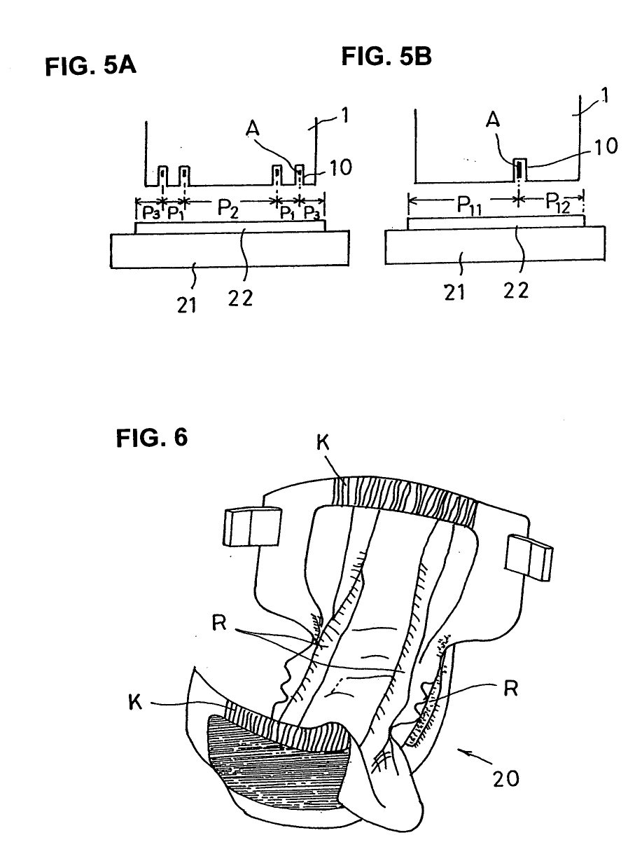

FIG. 5A shows a case of providing a plurality of rubber running slit grooves 10, and the adhesive agent H is applied to the plurality of string rubbers A or the like. Based on a position of such a plurality of rubber running slit grooves 10, mutual intervals P1 and P2 of the string rubbers A, and a positional relation P3 between the slit groove and a base material (band shaped diaper body 22) are restricted, thus making the slit groove 10 function as a guide.

FIG. 5B shows a case of applying the adhesive H to a single string rubber A or the like, by providing only one slit groove 10. Based on the position of the slit groove 10, the positional relations P11 and P12 between the slit groove and the base material (band shaped diaper body 22) are restricted, thus making the slit groove 10 function as a guide.

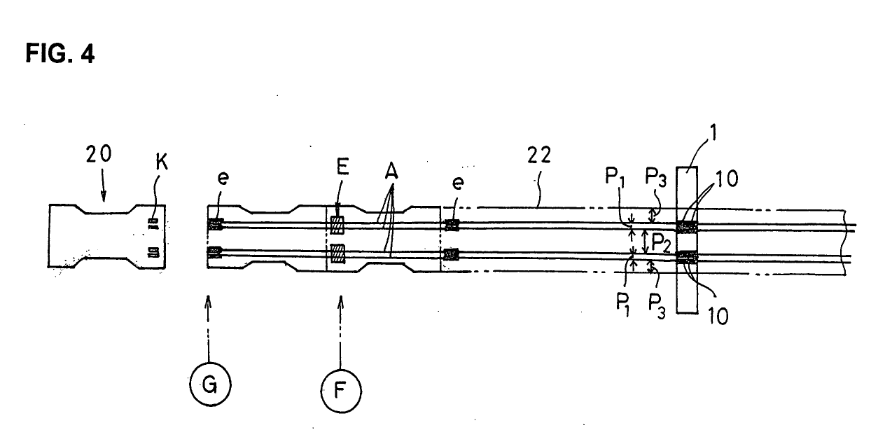

FIG. 4 shows an outline of the device B for applying adhesive agent to the elastic string-like material (polyurethane elastic string, flat rubber, string rubber or the like) A (hereinafter referred to as string rubber or the like), and reference numeral 1 denotes the coater applying head, reference numeral 2 denotes a valve mechanism, and reference numeral 3 denotes a hot-melt supply source. It is so constituted that the slit groove 10 is vertically formed in a lower end part of the coater applying head 1, a member to be bonded such as a string rubber A is made to horizontally penetrate the expanded part P, and the adhesive agent H is applied to the string rubber A or the like that passes through the slit groove 10.

With reference to FIG. 4 to FIG. 6, the coater applying head 1 includes a head body 1A, a distribution plate 1B, and a pressing plate 1C.

FIG. 4 shows the head body 1A in which an adhesive supply hole 11 is formed at its upper part so as to communicate with an adhesive agent hole 20 of the valve mechanism 2, a first distribution mechanism 12 having an adhesive horizontal supply passage 13 is formed at its middle part, and a plurality of rubber running slit grooves 10 are vertically formed at a lower end part.

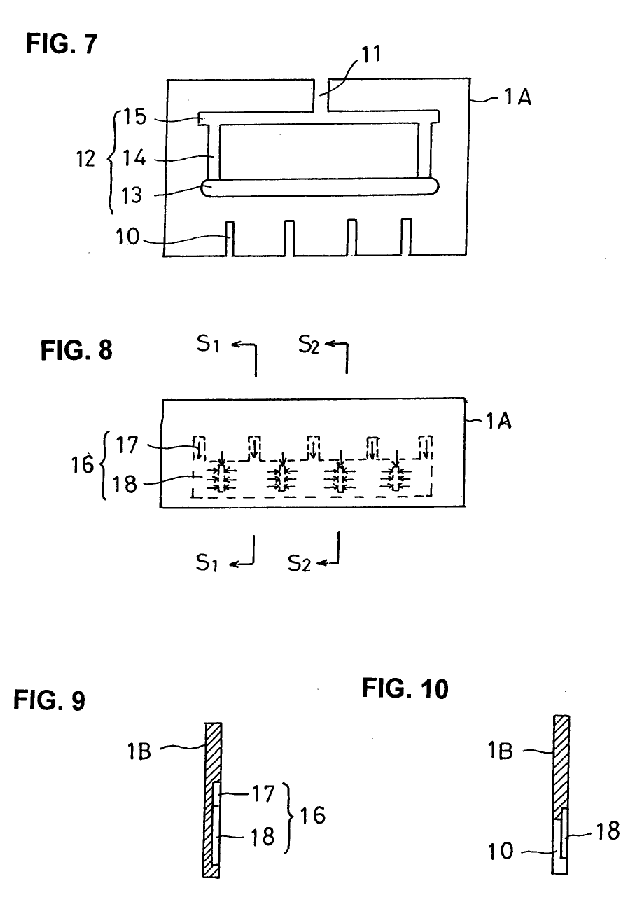

FIG. 7 shows the first distribution mechanism 12 in which an upper adhesive horizontal supply passage 15 and two adhesive longitudinal supply passages 14 (a plurality of adhesive longitudinal supply passages if desired) that communicates between the upper adhesive horizontal supply passage 15 and the adhesive horizontal supply passage 13, are added to form a loop structure, so that the adhesive agent H is supplied from both ends (both ends and a middle) of the adhesive horizontal supply passage 13. Note that the upper adhesive horizontal supply passage 15 can be omitted and only one adhesive longitudinal supply passage 14 may be provided, so as to communicate between the adhesive supply hole 11 and a central part of the adhesive horizontal supply passage 13.

FIG. 8 to FIG. 10 show the distribution plate 1B that forms a second distribution mechanism 16 including a plurality of longitudinal branch flow passages 17 disposed opposed to the adhesive horizontal supply passage 13 of the first distribution mechanism 12 of the coater applying head body 1A; and a distribution reservoir 18 that continues to the lower ends of the longitudinal branch flow passages 17 and disposed opposed to the rubber running slit groove 10 of the coater applying head body 1A.

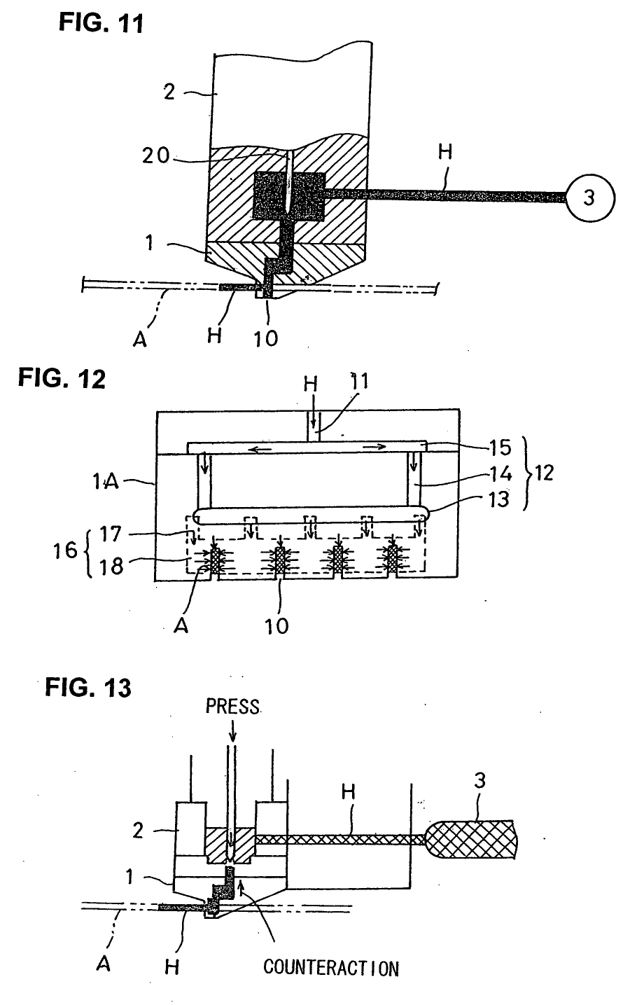

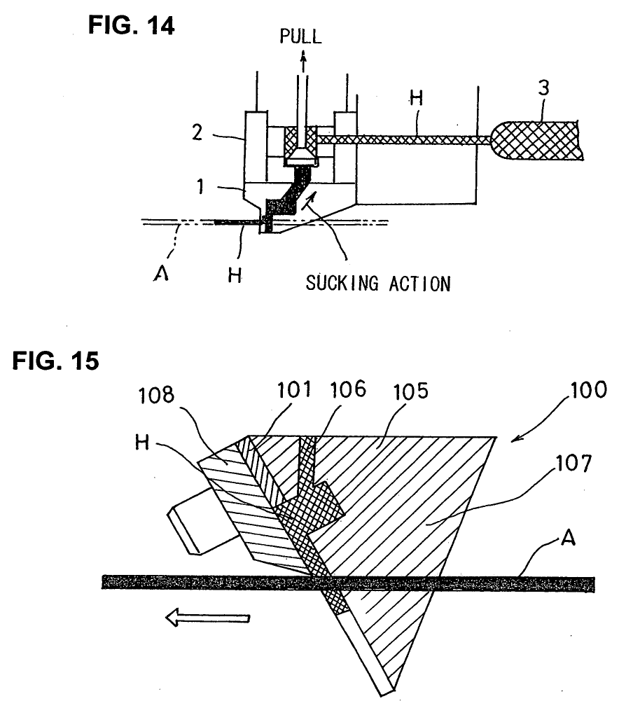

FIG. 11 shows a case of applying the adhesive agent to the string rubber or the like, by the method for applying adhesive agent to the string rubber or the like, in which a hot-melt is supplied from the hot-melt supply source 3 by off-and-on operation of the valve mechanism 2, to the adhesive supply hole 11 and the first distribution mechanism 12 through the valve mechanism 2, and to a plurality of rubber running slit grooves 10 having front face, rear face, and bottom face openings through the first distribution mechanism 12 and the second distribution mechanism 16.

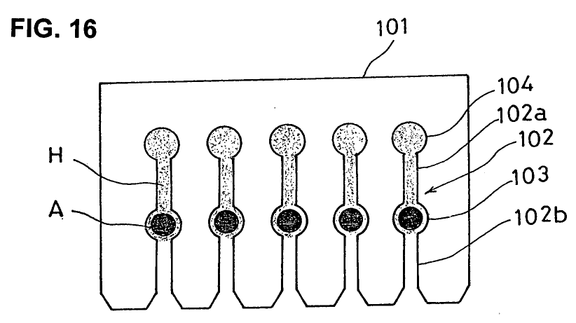

Depending on an operation type of the valve mechanism, an intermittent coating is possible by an intercept by a counteraction shown in FIG. 15 and by an intercept by a sucking action shown in FIG. 16.

The flow of the hot-melt in the adhesive supply hole 11, the first distribution mechanism 12, and the second distribution mechanism 16, in the coater applying head 1 is shown in FIG. 12.

In addition to the supply from the upper surface of the rubber running slit groove 10, the supply from a position closer to at least one side surface of the rubber running slit groove is added, to thereby apply the adhesive agent H to at least two surfaces of the string rubber or the like, that passes through the rubber running slit groove.

In addition to the supply from the upper surface of the rubber running slit groove 10, the supply from both side surfaces of the rubber running slit groove 10 is added, to thereby apply the adhesive agent H to three surfaces of the string rubber A or the like, that passes through the rubber running slit groove 10.

Next, the coater applying head 1 according to an example of the prior invention will be explained with reference to FIG. 15 to FIG. 19.

In the aforementioned coater applying head 1, the adhesive agent H is applied to two surfaces or three surfaces of the string rubber or the like. Meanwhile, according to the prior invention, the adhesive agent H is applied to an entire circumferential surface of the elastic string-like material (polyurethane elastic string, flat rubber, string rubber or the like).

FIG. 15 and FIG. 16 show a coater applying head 100, being the essential part of the device for applying adhesive agent in the prior invention, in which an expanded part (adhesive reservoir) 103 is formed in an intermediate part of a plurality of vertically arranged slit grooves 102 formed on a slit plate (distribution plate 1B) 101, and the elastic string-like material (polyurethane elastic string, flat rubber, string-like rubber or the like) is passed through the expanded part (adhesive reservoir) 103 filled with the adhesive agent H.

The slit groove 102 is divided into a tip part 102a at a lower side and a supply part 102b at an upper side of the expanded part (adhesive reservoir) 103, and the tip end of the supply part 102b is communicated with an adhesive supply opening 104.

The adhesive supply opening 104 of an upper end of the plurality of slit grooves 102 is communicated with an adhesive hole 105, through a communication groove (distribution groove in a lateral direction) 106. That is, the adhesive agent H supplied to the adhesive hole 106 is supplied to the adhesive supply opening 104 of each slit groove 102 through the communication groove (distribution groove in a lateral direction) 105, and the supply part 102b and the expanded part (adhesive reservoir) 103 are filled with the adhesive agent H.

As the distribution mechanism for supplying the adhesive agent H uniformly to the aforementioned plurality of slit grooves 102, the first distribution mechanism 12 and the second distribution mechanism 16 shown in FIG. 7, FIG. 8, FIG. 12 of the prior invention can be used.

In FIG. 15, reference numeral 107 denotes a head body, and reference numeral 108 denotes a pressing plate (blind plate). By making the elastic string-like material (polyurethane elastic string, flat rubber, string-like rubber or the like) penetrate the expanded part (adhesive reservoir) 103 of each slit groove 102, the adhesive agent H is applied on an entire circumferential surface of the elastic string-like material (polyurethane elastic string, flat rubber, string rubber or the like).

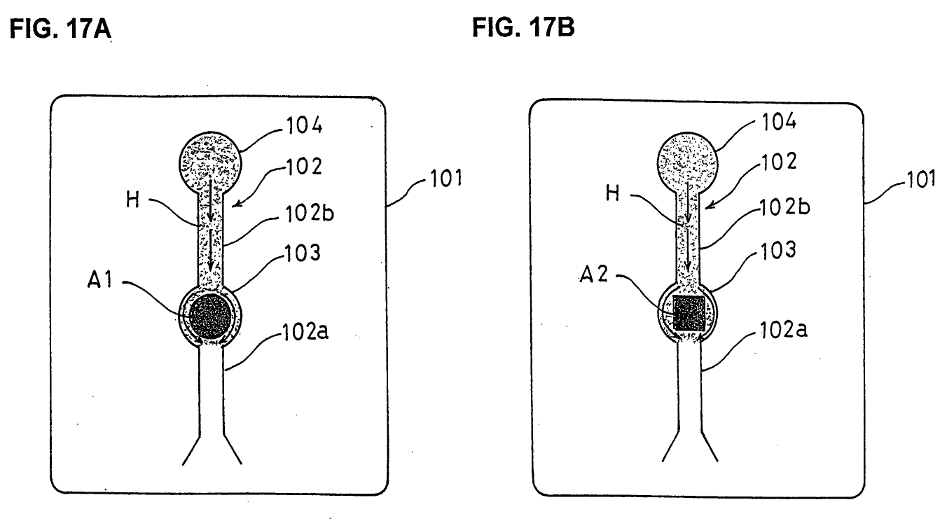

FIG. 17 shows an expanded slit groove 102, FIG. 17A shows a state that a string-like material A1, whose cross section is circular, penetrates this expanded part and FIG. 17B shows a state that the string-like material A1, whose cross section is rectangular, penetrates this expanded part.

In this way, the adhesive agent H is applied on the entire circumferential surface of the elastic string-like material (polyurethane elastic string, flat rubber, string rubber or the like) A that penetrates the expanded part (adhesive reservoir) 103 of the slit groove 102 having the above-described structure and running in a direction shown by arrow.

List of numerical values according to the prior invention is as follows.
Coating amount of the adhesive agent H 0.03 to 0.06 g/m (per one elastic string-like material)
String-like material
A round shaped string rubber 470 dtex
A square shaped string rubber 470 dtex
Running speed 150 m/mine
Minimum coating pitch (in case of a plurality of elastic string-like materials) 1.5 mm

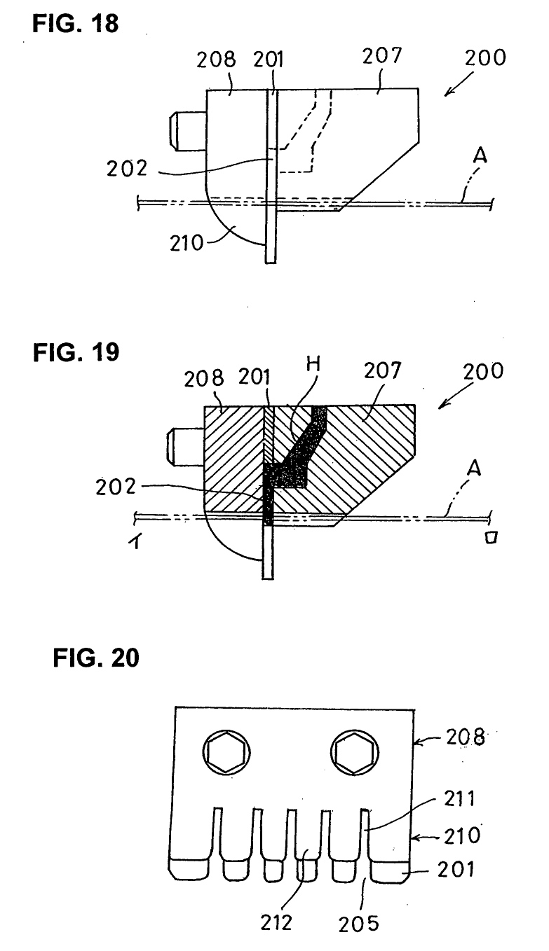

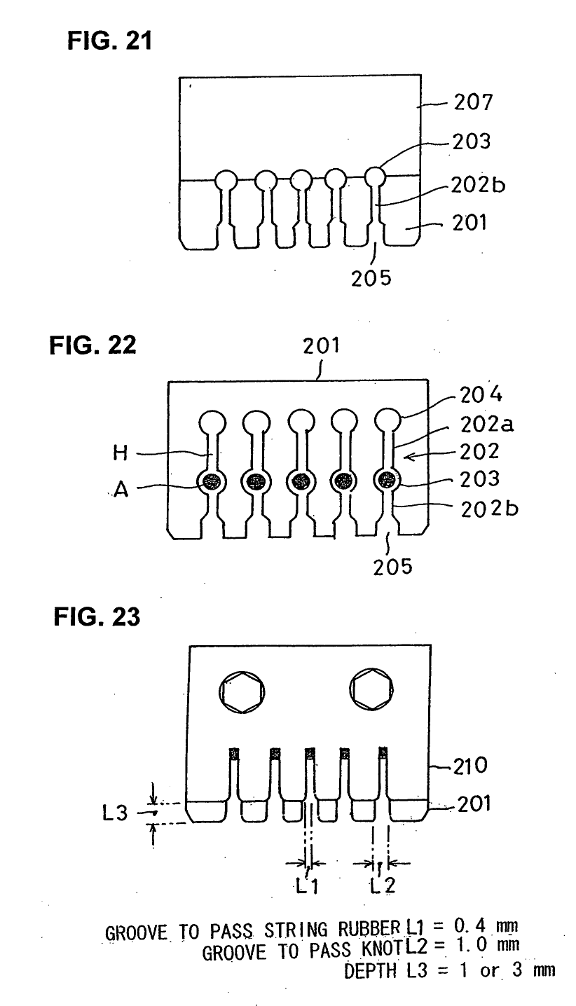

Next, explanation will be given to a first example of the present invention with reference to FIG. 18 to FIG. 22.

In a coater applying head 200, a slide guide body 210, which functions as a detecting means and a jump guide means, is positioned at an proceeding direction side of the elastic string-like material (polyurethane elastic string, flat rubber, string rubber or the like) A and is formed as a jump directional extending part of a pressing plate (blind plate) 208.

The slide guide body 210 has a slide face 212 inclined toward the tip end from the running line in side-view, and a detection guide groove 211 is formed in a jumping direction, so as to opposite to a tip part 202a of a slit groove 202.

A width of the detection guide groove 211 is set larger than a sectional face of the elastic string-like material (polyurethane elastic string, flat rubber, string rubber or the like) A, to allow the elastic string-like material (polyurethane elastic string, flat rubber, string rubber or the like) A to pass through freely. However, the width of the detection guide groove 211 is set smaller than the sectional face of a knot P to lock the knot P therein and inhibit a direct advance of the knot P, thus guiding the knot P to a jump position of the tip part of the slide guide body 210.

A second expanded part 205 is formed at the tip end of the slit groove 202 of the slit plate 201, to allow the knot P to pass through.

Regarding the head body 207, the head body 107 of the prior invention is formed to have an opening at a position closer to a jump position from a penetrating position of the elastic string-like material (polyurethane elastic string, flat rubber, string rubber or the like) A, so that the elastic string-like material (polyurethane elastic string, flat rubber, string rubber or the like) A after jump can be landed on an coating line.

FIG. 23 shows a numerical value of each part in the first example.

String rubbers of 470 dtex to 520 dtex will be given as an example.

Groove L1 to allow the string rubber to pass through=0.4 mm

Groove L2 to allow the knot to pass through=1.0 mm

Depth L3=1 to 3 mm

A groove width of the slit groove is different in proportion to a thickness (dtex) of the string rubber. Note that the coating amount of the adhesive agent H, the string-like material, a running speed minimum coating pitch (in case of a plurality of elastic string-like materials) have the same numerical values as the numerical example of the prior invention.

The aforementioned numerical values are shown as reference examples for understanding the present invention, and various embodiments can be selected. That is, the embodiment can be suitably selected by a publicly-known art and know-how adapted to the characteristic of the adhesive agent H, an object base material to be bonded (a material of a top sheet of a paper diaper or a shape of the paper diaper or the like) and property and shape of the string-like material.

Next, the application operation according to the present invention will be explained.

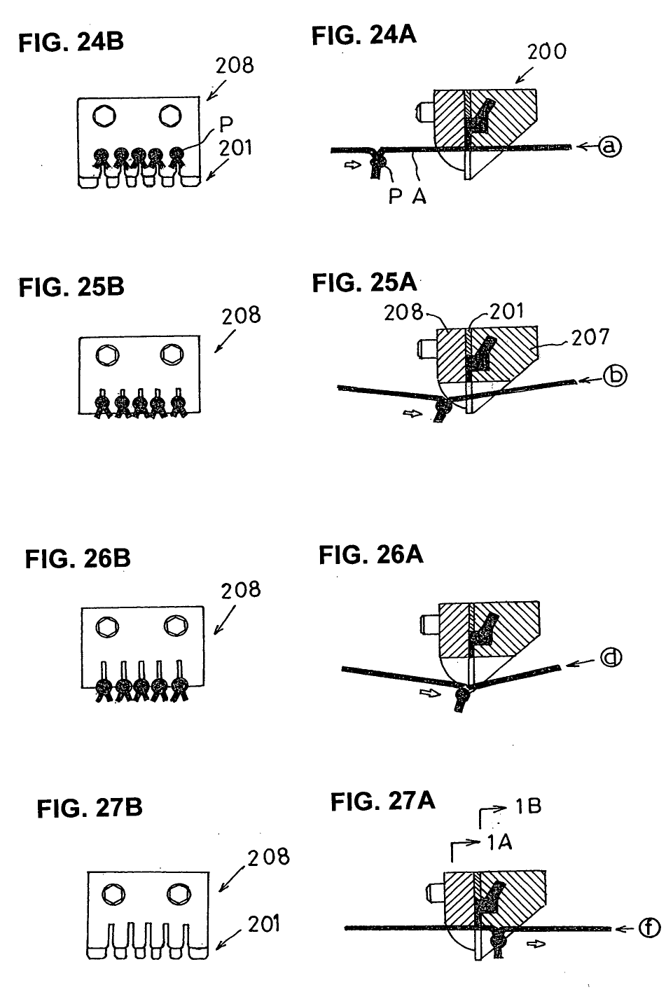

(a) The knot P approaches the coater applying head 200 (shown in FIG. 24).

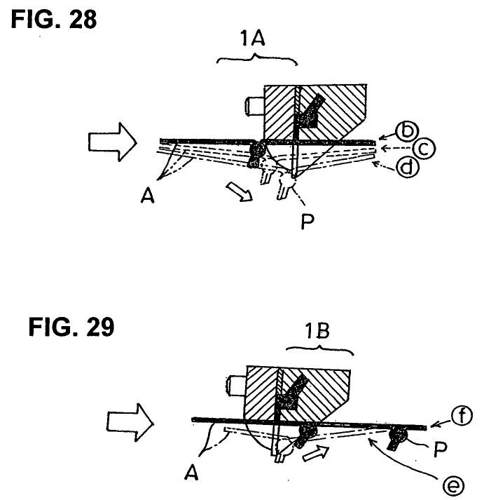

(b) The knot P comes in contact with a base part of the slide guide body 210 (shown by solid line in FIG. 28).

(c) The knot P is guided by the detection guide groove 212 along a slide face 211 of the slide guide body 210, and is moved in a jumping direction. (shown by dotted line in FIG. 25 and FIG. 28).

(d) The knot P reaches the tip end of the slide guide body 210 and passes through the second expanded part 205 of the slit groove 202 (shown by one dot chain line in FIG. 26 and FIG. 28).

(e) The knot P overleaps the slit plate 201, and drops toward a guide face 207a of the head body 207 (shown by one dot chain line in FIG. 29).

(f) The knot P lands on the guide face 207a of the head body 207 (shown by solid line in FIG. 27 and FIG. 29).

Thus, the knot P overleaps and avoids the tip part 202a of the slit groove 202 of the slit plate 201 by jumping and passes through the slit groove 202.

In starting the aforementioned application operation, when the knot P that approaches the coater applying head 200, comes in contact with the base part of the slide guide body 210, an advancement of the knot P receives a resistance, and therefore the knot P is guided to be automatically positioned on the front face of the slit groove 202 (note that in the aforementioned state of (a) in FIG. 24, the knot P approaches the coater applying head 200 in a downward (vertical) state to the string rubber, etc. However, the advancement of the knot P receives the resistance even when the knot P is not set in a downward sate (vertical state) but set in a tilted state in right or left, in a lateral state (horizontal state), and in an upward state (vertical state), thus generating a torsion in the string rubber, etc, in the middle of passing through the coater applying head 200. Therefore, the knot P is guided to be automatically positioned on the front face of the slit groove 202).

As a result, when the knot P reaches the state of the aforementioned (d), the knot P is guided to be positioned at the tip end of the slide guide body 210 without fail, thus making it possible to pass through the second expanded part 205 of the slit groove 202 without trouble.

In the above-described embodiment, there exists a section where no adhesive agent is applied, in the before and behind the knot P. However, the rubber string expands and shrinks from an extension state to a natural sate, to change the length of the section where no adhesive agent applies. Therefore, this length can be substantially ignored, having no adverse effect on a bonding action between the base material and the string rubber. This contributes to surely and excellently bonding a plurality of approaching string rubbers, etc, to the base material.

According to the above-described example, in the coater applying head 200 that performs coating action on a lower face, a jumping system, with the head body 207 directed downward, is provided. However, according to the present invention, in case of the coater applying head 200 that performs coating action on a lateral face and upper face, the knot jumps laterally or upward.

The present invention has an advantage that the knot of the elastic string-like material running on the coater applying head is detected, and the knot is raised from the original running line passing through the slit groove of a slit nozzle coating part, so that it can pass while avoiding the slit groove, and it is returned to the original running line to run continuously. Therefore, even when replacing the supplying bobbin, the application operation needs not to be stopped, thus improving work efficiency by a continuous work of the application operation.

### INDUSTRIAL APPLICABILITY

The present invention contributes to a development of an industry in which a body fluid absorbent product and other textile processed product are manufactured, when it is applied to a coating step of applying the adhesive agent to a required elastic string-like material (polyurethane elastic string, flat rubber, and string rubber or the like), in a manufacturing apparatus of the body fluid absorbent product (a disposable diaper or the like) including the step of gluing the elastic string-like material (polyurethane elastic string, flat rubber, and string rubber or the like).

1-6. (canceled)

7: A method for applying an adhesive agent to an elastic string-like material, having a coating line including the step of applying the adhesive agent to a running elastic string-like material by a coater applying head, for supplying the adhesive agent to a slit groove, which communicates with an adhesive supply hole and has an open lower face and an expanded middle part, making a tense elastic string-like material penetrate the expanded part of the slit groove horizontally, and supplying the elastic string-like material in a coating line proceeding direction, so that the adhesive agent is applied on an entire circumferential surface of the string-like material passing through the slit groove, the method comprising:
detecting a knot that exists in the elastic string-like material running on the coater applying head; based on a detection of the knot, so that it can pass while avoiding the slit groove, the knot of the elastic string-like material is promptly returned to the original running line,
wherein the knot of the elastic string-like material jumping and passing through the slit groove of a slit nozzle of a slit nozzle coating position is promptly returned to the running line and can be continuity running.

8: A method for applying an adhesive agent to an elastic string-like material, having a coating line including the step of applying the adhesive agent to the plurality of running elastic string-like material by a coater applying head, for supplying the adhesive agent to the plurality of slit groove, which communicates with an adhesive supply hole and has an open lower face and an expanded middle part, making a tense elastic string-like material penetrate the expanded part of the slit groove horizontally, and supplying the elastic string-like material in a coating line proceeding direction, so that the adhesive agent is applied on an entire circumferential surface of the string-like material passing through the slit groove, the method comprising:
detecting a knot that exists in the elastic string-like material running on the coater applying head; based on a detection of the knot, so that it can pass while avoiding the slit groove, the knot of the elastic string-like material is promptly returned to the original running line,
wherein the knot of the elastic string-like material is guided in a jumping direction, for automatically jumping the knot of the elastic string-like material from the running line of the elastic string-like material.

9: An apparatus for applying an adhesive agent to an elastic string-like material including a slit plate having a slit groove that communicates with an adhesive supply hole, for applying an adhesive agent to a running elastic string-like material, said apparatus comprising:
a slide guide body positioned at a front part in a transfer direction of a slit plate of the coater applying head, having a detection guide groove with a width of allowing the elastic string-like material to pass through in an extension state but inhibiting the knot from passing through, with the detection guide groove aligned with the slit groove of the slit plate in a transfer direction of the elastic string-like material,
so that a guide terminal end of said slide guide body is approached to a tip end of the slit groove of the slit plate.

10: An apparatus for applying an adhesive agent to an elastic string-like material including a slit plate having a plurality of slit grooves that communicate with an adhesive supply hole, for applying an adhesive agent to a plurality of running elastic string-like materials, said apparatus comprising:
a slide guide body positioned at a front side of the slit plate in a transfer direction, having a detection guide groove with a width of allowing the elastic string-like material to pass through but inhibiting the knot from passing through, and having a second expanded part positioned at a part protruded from a tip end of the slide guide body at a tip end extension part of the slit groove of said slit plate, with a width of allowing the knot to pass through.
